(19) United States
(12) Patent Application Publication
(10) Pub. No.: US 2019/0236909 A1
(43) Pub. Date: Aug. 1, 2019

(54) METHOD AND APPARATUS FOR SIMULATING BETTING IN REAL TIME

(71) Applicant: WBKM, Limited, Valletta (MT)

(72) Inventors: Macksim Blayvas, Vaughan (CA); Dimitry Behak, Toronto (CA)

(21) Appl. No.: 16/376,130

(22) Filed: Apr. 5, 2019

Related U.S. Application Data
(63) Continuation of application No. 15/641,185, filed on Jul. 3, 2017, now abandoned.
(60) Provisional application No. 62/357,707, filed on Jul. 1, 2016.

(51) Int. Cl. G07F 17/32

(52) U.S. Cl. CPC G07F 17/3288; G07F 17/3225; G07F 17/3211

(57) ABSTRACT

A system for simulating betting in real time on sporting events. The system includes a server and at least one of a plurality of computing devices. The server receives sporting event details for a sporting event. The at least one of the plurality of computing devices includes a user interface to input a bet on the sporting event. The server receives the bets on the sporting event from the at least one of the plurality of computing devices and calculates a bet out value depending on betting data received from the at least one of the plurality of computing devices. The at least one of the plurality of computing devices includes a display to show the bet out value in response to receiving the bet out value from the server.

### CROSS-REFERENCE TO RELATED APPLICATIONS

The present application is a continuation of U.S. application Ser. No. 15/641,185, entitled “METHOD AND APPARATUS FOR SIMULATING BETTING IN REAL TIME,” filed on Jul. 3, 2017, which claims priority to and the benefit of U.S. Provisional Patent Application No. 62/357,707, filed on Jul. 1, 2016, the disclosure of which is now incorporated herein by reference in its entirety.

### BACKGROUND

The present disclosure relates to systems, components, and methodologies for a betting game. More particularly, the present disclosure relates to systems, components, and methodologies that offer fast-paced in-game simulated sports betting in real time on sporting events.

### SUMMARY

The present disclosure may comprise one or more of the following features and combinations thereof.

According to the present disclosure, systems, components, and methodologies are provided for simulating sports betting in real time on sporting events.

In illustrative embodiments, a sports betting game may simulate sports betting in real time on sporting events. In illustrative embodiments, sports included that may be betted on may be at least one of professional football, baseball, soccer, basketball, rugby, tennis, cricket, hockey, and other sports. In other embodiments, the sports included also include e-sports which may be computer games with real bet in statistics. For example, one computer game with real bet in statistics is DOTA2.

In illustrative embodiments, the sports betting game may have at least one of a plurality of different game modes to choose to play. In some embodiments, the different modes may include at least one of a real play mode, virtual play mode, retro play mode, and multiplayer mode. In other embodiments, other game modes may be included to provide a different experience in the sports betting game. In one embodiment, all of the sports may be included in each different game mode. In other embodiments, certain sports may only be available for certain game modes. Real play mode may be embodied as a game mode to provide betting in real time on live sporting events. Virtual play mode may be embodied as a game mode to provide betting on simulated games or virtual sports. Virtual sports are simulated sports based on an analysis of thousands of real games. Virtual sports may be focused on realism with number of events, leagues/tournaments, graphical display, betting markets, and the gameplay. In some embodiments, virtual sports are based on real-match statistics so betting on a virtual sports feels the same as betting on the real thing. Retro play mode may be embodied as a game mode to provide betting on historical sports events. A player of the sports betting game will bet on a specific time window of historical sport event. A bet result of the historical sport event is calculated by the historical match that was already played between those teams in the match. At least one of an event date and time, event location, or bet in time may not be provided to the player for retro play mode. Multiplayer mode may be embodied as a game mode to provide betting on real events against friends or anyone else worldwide. In another embodiment, multiplayer mode may be embodied as a game mode to provide betting on virtual sports or historical sports.

In at least one embodiment, the sports betting game may be designed for at least one iOS, Android, or web-integrated application.

In another embodiment, the sports betting game may use a slot-machine strategy for multi-betting placement of odds and stakes. The slot-machine strategy may make winning based on placing multiple bets and calculating the relationship between the bets whether it's a visual pattern or otherwise, which may determine various types of incentives or payouts or the bet result itself.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

For the purposes of promoting an understanding of the principles of the disclosure, reference will now be made to a number of illustrative embodiments illustrated in the drawings and specific language will be used to describe the same.

The detailed description particularly refers to the accompanying figures in which:

FIG. 1 is a simple diagram illustrating an example system for aggregating data and providing a game according to an embodiment of this disclosure;

FIG. 2 is an exemplary home screen for a sports betting game in accordance with the present disclosure;

FIG. 3 is an exemplary screen of several accumulated bets made in the sports betting game in accordance with the present disclosure;

FIG. 4 is an exemplary screen of placing a bet within the sports betting game in accordance with the present disclosure;

FIG. 5 is an exemplary screen for betting out of a placed bet within the sports betting game in accordance with the present disclosure;

FIG. 6 is an exemplary screen for locating a leader board and personal statistics on betting in accordance with the present disclosure;

FIG. 7 is another exemplary screen of several accumulated bets made in the sports betting game in accordance with the present disclosure;

FIG. 8 is an exemplary screen of utilizing the filters of the sports betting game in accordance with the present disclosure;

FIG. 9 is an exemplary screen for buying more currency to bet within the sports betting game in accordance with the present disclosure;

FIG. 10 is an exemplary screen for winning a bet within the sports betting game in accordance with the present disclosure;

FIG. 11 is an exemplary screen for joining a room to bet within the sports betting game in accordance with the present disclosure;

FIG. 12 is an exemplary screen for creating a new room to bet within the sports betting game in accordance with the present disclosure;

FIG. 13 is an exemplary screen for choosing a side to bet on within the sports betting game in accordance with the present disclosure; and

FIG. 14 is an example flow chart of a method for simulating betting in real time on sporting events in accordance with the present disclosure.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

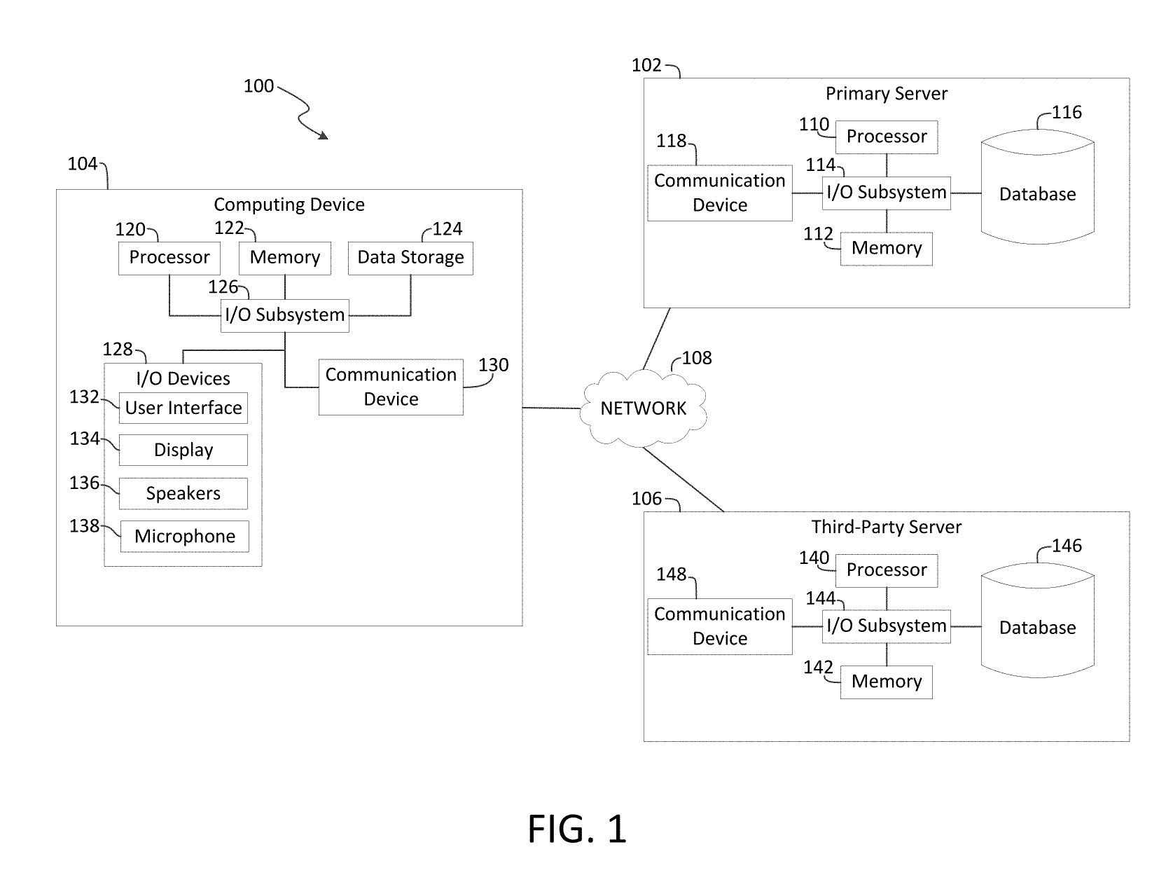

Referring now to FIG. 1, an illustrative system 100 for simulating betting in real time includes a primary server 102 connected to a computing device 104 and a third-party server 106 through a network 104. Although FIG. 1 shows only one primary server 102, one computing device 104, and one third-party server 106, there may be any number of these computing devices and servers. In use, as described below, the primary server 102 may manage, implement, and service a simulation of sports betting in real time on sporting events. These sporting events that can be betted on may include at least one of professional football, soccer, basketball, rugby, tennis, cricket, hockey, and other sports. In other embodiments, the list of sports may also include e-sports as described above. In the illustrative embodiment, the computing device 104 may run the sports betting game in various game modes. The various game modes may include at least one of a real play mode, virtual play mode, retro play mode, and multiplayer mode. In one embodiment, the simulated sports betting in real time on sporting events may be a social game where users compete with one another.

In an illustrative embodiment, the real play mode may include betting on sporting events that are happening in real-time. The virtual play mode may include betting on a simulated sporting event based on data collected by the primary server 102. The retro play mode may include betting on a past sporting event that is logged into the primary server 102.

The primary server 102 may calculate a bet out value for a sporting event that a user of the computing device 104 bets on based on the probability of an outcome happening. For example, if the user of the computing device bets on team A for a sporting event between team A and team B, then the primary server 102 may calculate a bet out value for the sporting event. The bet out value is a cash out value at any time prior to the ending of the sporting event. Furthermore, the bet out value is calculated based on the likelihood of the outcome occurring. To continue the example, the primary server 102 calculates how likely team A will win the sporting event and determines a bet out value from that likelihood. This results in a higher bet out value for a team that is likely to win. The bet out value may fluctuate throughout the sporting event depending on how likely the team betted on is likely to win. The bet out value may be miniscule or nonexistent if the primary server 102 determines a team is unlikely to win.

In an illustrative embodiment, the simulated sports betting in real time on sporting events may include a strategic slot-machine style multi-betting placement of odds and stakes displayed on the computing device 104. The slot-machine strategy may make winning based on placing multiple bets and calculating the relationship between the bets whether it's a visual pattern or otherwise, which may determine various types of incentives or payouts or the bet result itself as described above. For example, the primary server 102 may combine various bets together to generate one payout.

In one embodiment, the simulated sports betting may be embodied in a multi-platform mobile game for a computing device 104 that is powered by for example a robust, enterprise level CRM system on a primary server 102. The embodied game is wrapped in a high-resolution dynamic graphical front-end, and based on continually evolving and expanding gameplay mechanics and options, the application and the supporting framework is designed from the ground up to ensure maximum player retention and robust big-data analysis, and provide effective and cost-efficient commercial utilization opportunities.

In one embodiment, the system 100 serves all data required to manage and support a 360-degree overview of user base, and helps identify opportunities and formulate strategies to maximize the potential across verticals markets.

In one embodiment, the system illustratively 100 includes a robust platform, for example a CRM platform, that includes modules that comprises at least one of a game settings management (with instant update of mobile devices), player management with 360-degree view on user activities, lead management with seamless integration to external lead providers, retention management, help and customer care, virtual bank management, sophisticated analytics and reporting tools, marketing features, seamless integration to leadings sports data provider, advanced security features, including permission management, audit trail, and field security, 3M (Multi Lingual/Multi Currency/Multi Tenancy), and “white label” ready.

The primary server 102 may be embodied as any type of computation or computer device capable of performing the functions described herein, including, without limitation, a computer, a multiprocessor system, a server, a rack-mounted server, a blade server, a laptop computer, a notebook computer, a network appliance, a web appliance, a distributed computing system, a processor-based system, and/or a consumer electronic device. As shown in FIG. 1, the primary server 102 illustratively includes a processor 110, a memory 112, an input/output (I/O) subsystem 114, a database 116, and a communication device 118, and/or other components and devices commonly found in a server computer or similar computing device. Of course, the primary server 102 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor 110 in some embodiments.

The processor 110 may be embodied as any type of processor capable of performing the functions described herein. For example, the processor 110 may be embodied as a single or multi-core processor(s), digital signal processor, microcontroller, or other processor or processing/controlling circuit. The memory 112 may be embodied as any type of volatile or non-volatile memory or data storage capable of performing the functions described herein. In operation, the memory 112 may store various data and software used during operation of the compute device 102 such operating systems, applications, programs, libraries, and drivers. The memory 112 is communicatively coupled to the processor 110 via the I/O subsystem 114, which may be embodied as circuitry and/or components to facilitate input/output operations with the processor 110, the memory 112, and other components of the primary server 102. For example, the I/O subsystem 114 may be embodied as, or otherwise include, memory controller hubs, input/output control hubs, sensor hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 114 may form a portion of a system-on-a-chip (SoC) and be incorporated, along with the processor 110, the memory 112, and other components of the primary server 102, on a single integrated circuit chip.

The database 116 may be embodied as any type of device or devices configured for short-term or long-term storage of data such as, for example, memory devices and circuits, memory cards, hard disk drives, solid-state drives, non-volatile flash memory, or other data storage devices. The primary server 102 may also include a communication device 118, which may be embodied as any communication circuit, device, or collection thereof, capable of enabling communications between the primary server 102 and other devices and/or servers over the network 108. For example, the communication device 118 may be embodied as or otherwise include a network interface controller (NIC) for sending and/or receiving network data with remote devices. The communication device 118 may be configured to use any one or more communication technology (e.g., wired or wireless communications) and associated protocols (e.g., Ethernet, InfiniBand®, Bluetooth®, Wi-Fi®, WiMAX, 3G, 4G LTE, etc.) to effect such communication.

In some embodiments, the primary server 102 may be embodied as separate servers in order to perform separate tasks, similar tasks, or a combination of separate and similar tasks. For example, there may be a separate primary server 102 to receive input from the computing device 104 and process that input and another separate primary server 102 to receive input from the third-party server 106.

An illustrative embodiment of the computing device 104 is shown in FIG. 1. The computing device 104 may be configured to receive data from the primary server 102 and send data to the primary server 102 to be processed and utilized to manage the game. The computing device 104 may be embodied as any type of computation or computer device capable of performing the functions described herein, including, without limitation, a computer, a multiprocessor system, a laptop computer, a notebook computer, a network appliance, a web appliance, a distributed computing system, a processor-based system, and/or a consumer electronic device. As shown in FIG. 1, the computing device 104 illustratively includes a processor 120, a memory 122, a data storage 124, an input/output (I/O) subsystem 126, input/output (I/O) devices 128, and a communication device 130, and/or other components and devices commonly found in a similar computing device. In some embodiments, one or more of the illustrative components may be incorporated in, or otherwise form a portion of, another component. For example, the memory 122, or portions thereof, may be incorporated in the processor 120 in some embodiments. The various components of the computing device 104 function similarly to the similar components included in the primary server 102 as discussed above. The various components of the computing device 104 may also be similarly embodied as the components in the primary server 102. Similarly to the database 116 of the primary server 102, the data storage 124 may store information on the computing device 104.

The I/O Devices 128 may include a user interface 132, a display 134, speakers 136, and a microphone 138. As discussed below, these I/O devices 128 may be used to receive input from the user and output a game to the user. The user interface 132 may include any combination of input/output devices, such as, for example, buttons, keyboard, or a computer touchscreen. For example, the user may input account information through the user interface 132 to send to the primary server 102. The display 134 and speakers 136 may display the game and provide game audio for the user. In some embodiments, the microphone 138 may capture information verbally presented by the user. In another embodiment, the I/O devices 128 may include other devices to input and output information to and from the user on the computing device 104. The computing device 104 may send all of the information collected to the primary server 102.

An illustrative embodiment of the third-party server 106 is shown in FIG. 1. In the embodiment shown, the third-party server 106 may include many of the similar components as the primary server 102. The third-party server 106 may be configured to communicate with the primary server 102 and/or the computing device 104 in order to send data to the right destination. The third-party server 106 may be configured to communicate with both of the computing device 104 and the primary server 102. The third-party server 106 illustratively includes a processor 140, a memory 142, an I/O subsystem 144, a database 146, and a communication device 148. Each of the processor 140, memory 142, I/O subsystem 144, database 146, and communication device 148 functions similarly as the similar components of the primary server 102 as described above. Each of the processor 140, memory 142, I/O subsystem 144, database 146, and communication device 148 may also be embodied similarly to the corresponding components of the primary server 102.

In the embodiment shown, the third-party server 106 may be embodied as any type of computation or computer device capable of performing the functions described herein, including, without limitation, a computer, a multiprocessor system, a server, a rack-mounted server, a blade server, a laptop computer, a notebook computer, a network appliance, a web appliance, a distributed computing system, a processor-based system, and/or a consumer electronic device. Of course, the third-party server 106 may include other or additional components, such as those commonly found in a server device (e.g., various input/output devices), in other embodiments. Additionally, in some embodiments, one or more of the illustrative components may be incorporated in, or otherwise form a portion of, another component. For example, the memory 142, or portions thereof, may be incorporated in the processor 140 in some embodiments.

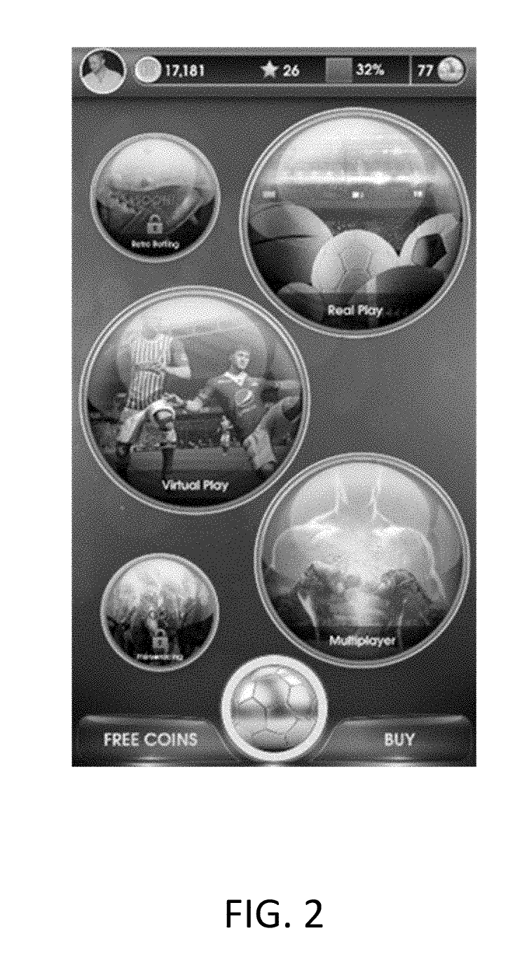

Referring to FIG. 2, an illustrative embodiment of a screen of the computing device 104 is shown for a home screen during implementation of the sports betting game on the computing device 104. The home screen may include the various play modes to be selected and player information such as, total amount of currency, level, profile information, etc. The home screen may also include options to purchase more in-game currency and ways to receive free coins.

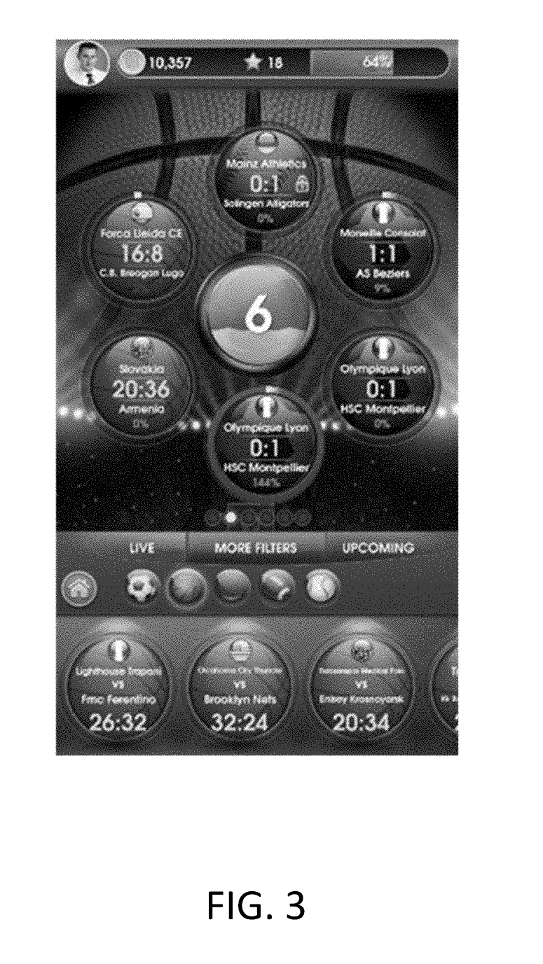

Referring to FIG. 3, an illustrative embodiment of a screen of the computing device 104 is shown for several accumulated bets made in the sports betting game on various sporting events. The icons of the various bets may be displayed according to the related sporting event. The accumulated bets may be displayed on the computing device 104 in a slot-machine style as described above. Other sporting events that may be betted on may be displayed down below.

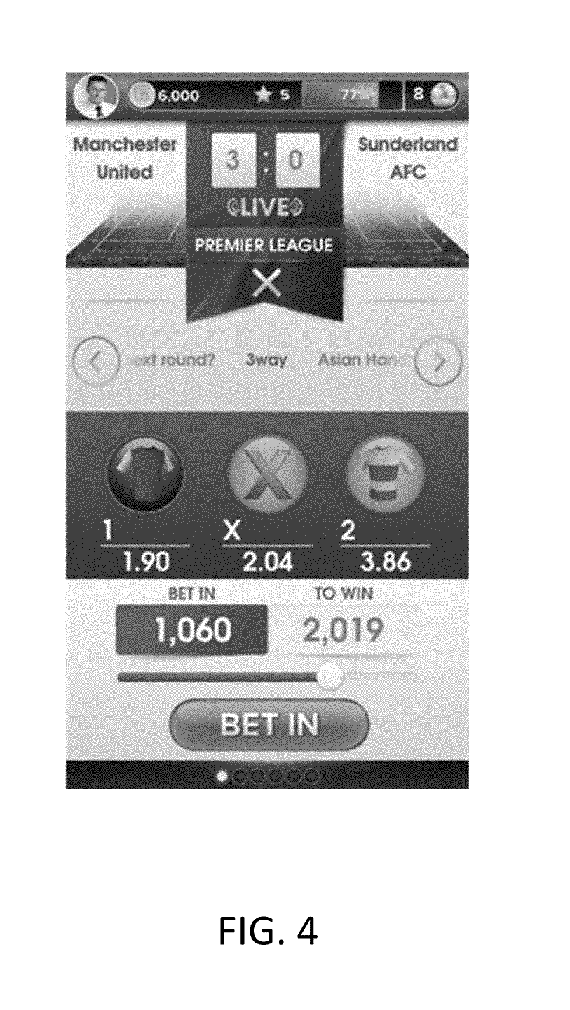

Referring to FIG. 4, an illustrative embodiment of a screen of the computing device 104 is shown for placing a bet on the computing device 104. The screen of computing device 104 may include the amount to bet into the sporting event. The live score of the event may be included on the screen of the computing device 104.

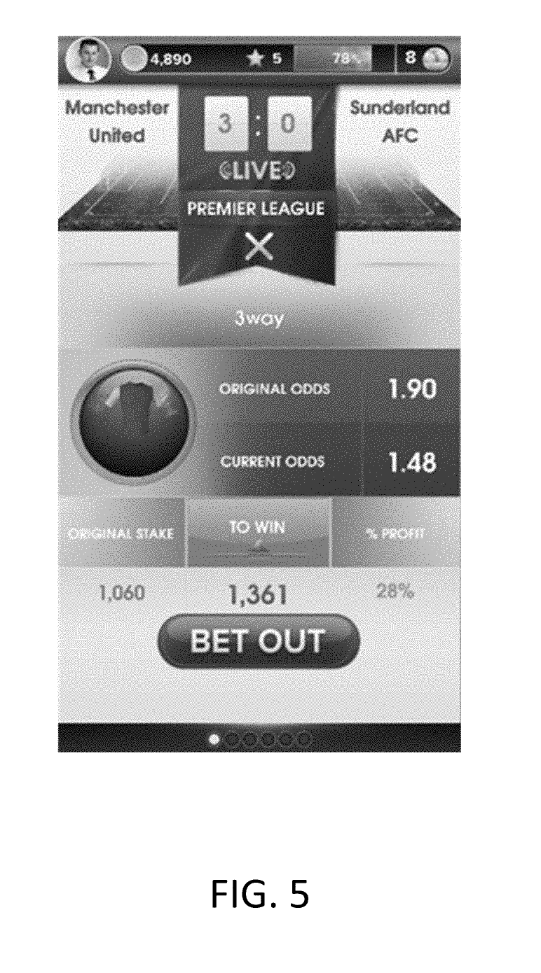

Referring to FIG. 5, an illustrative embodiment of a screen of the computing device 104 is shown for the betting out screen including a bet out value and the percent gain from the original amount. The odds may be displayed on the screen of the computing device 104.

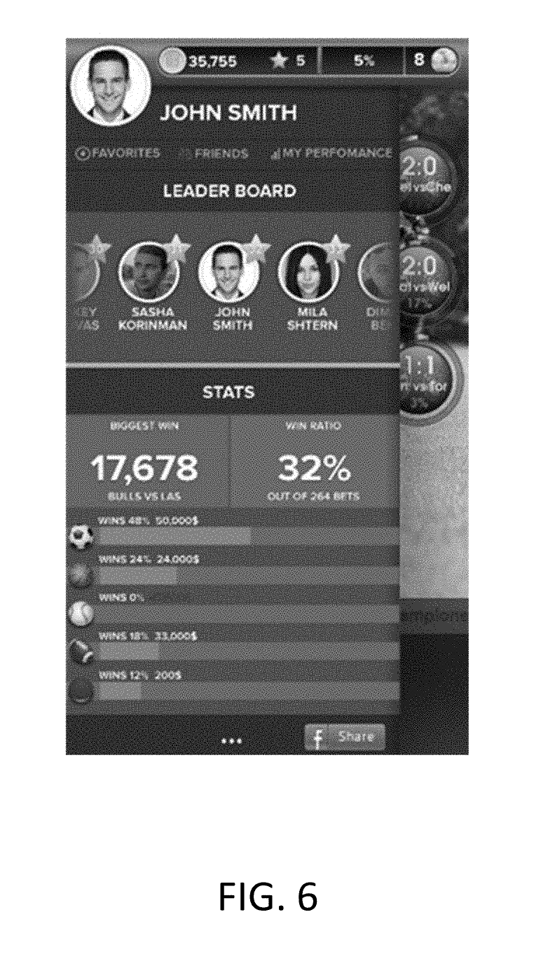

Referring to FIG. 6, an illustrative embodiment of a screen of the computing device 104 is shown for a leaderboard for a user profile. Other details of the user profile may be included such as, percentage of wins and bets that the user may have placed during the lifetime of playing the game.

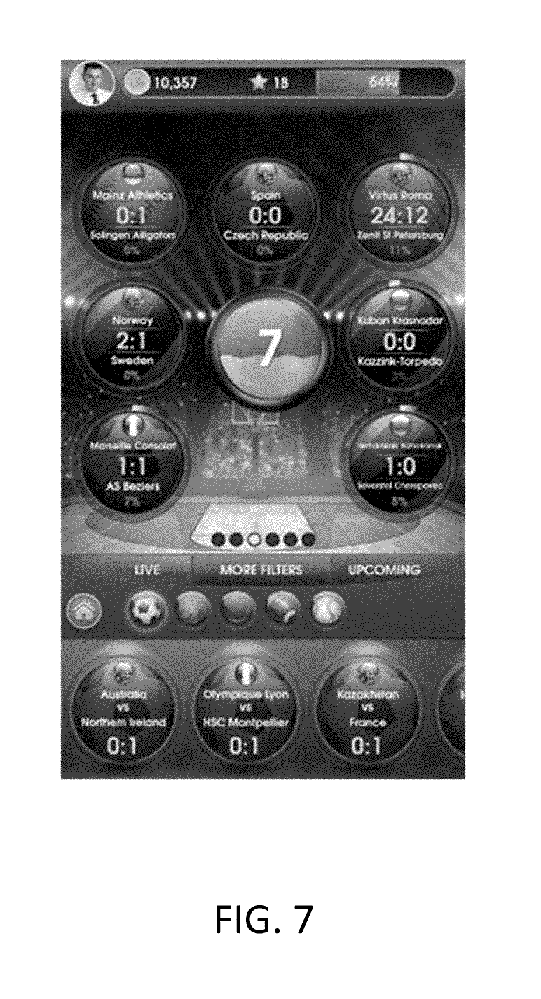

Referring to FIG. 7, another embodiment of the screen of the computing device 104 is shown for several accumulated bets made in the sports betting game on various sporting events similar to FIG. 3.

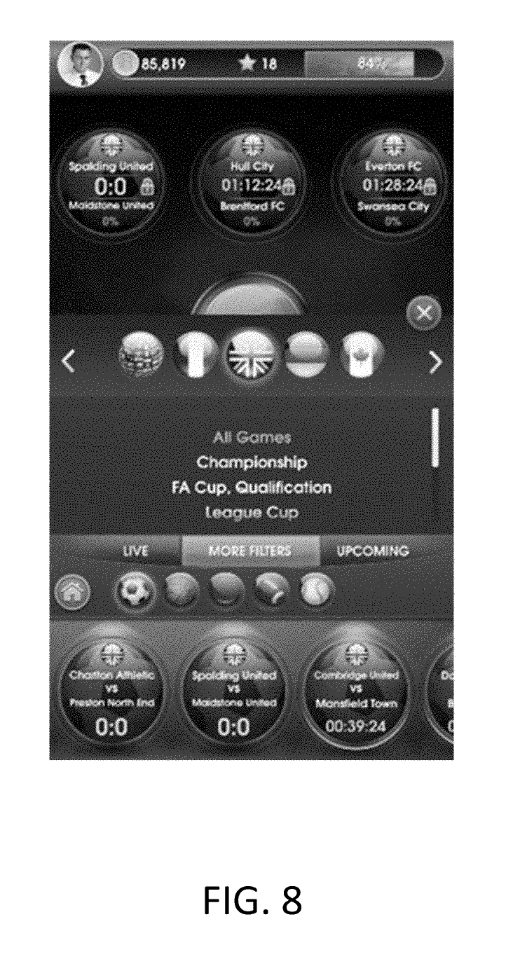

Referring to FIG. 8, an illustrative embodiment of a screen of the computing device 104 is shown for selecting an event to bet on. The collection of events includes the various sports that may be betted on. The screen may include different sportings events for different countries.

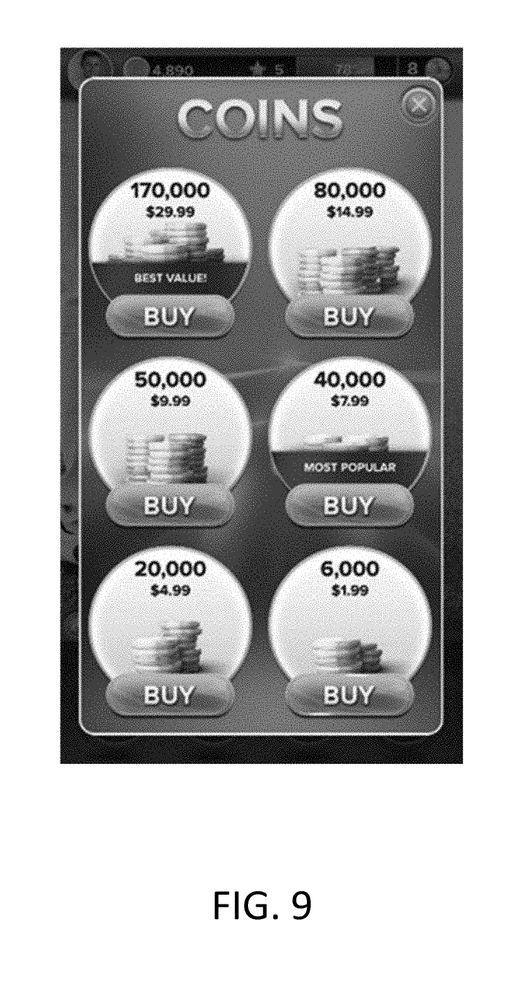

Referring to FIG. 9, an illustrative embodiment of a screen of the computing device 104 is shown for buying additional in game currency. Various amounts of in-game currency may be purchased for various amounts of real-world money.

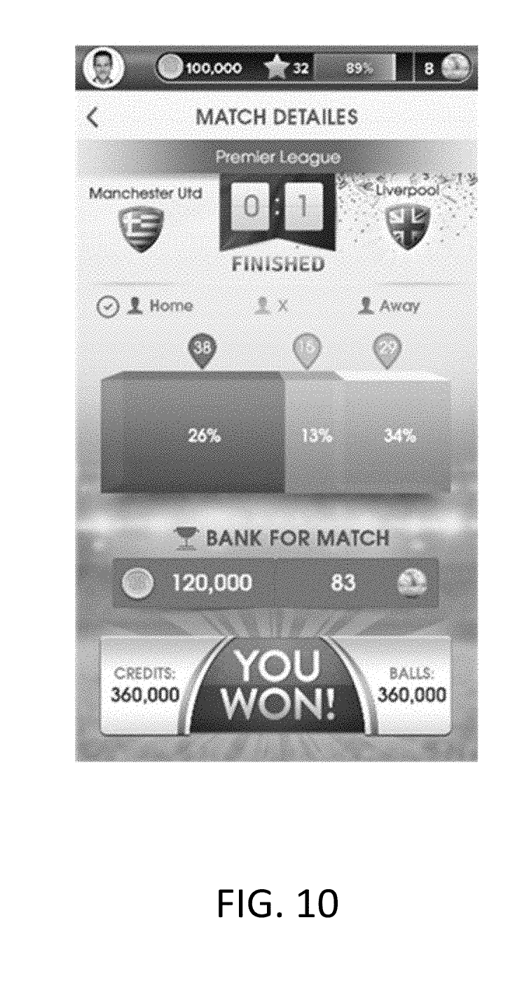

Referring to FIG. 10, an illustrative embodiment of a screen of the computing device 104 is shown for the closing page for the completion of a sporting event. The screen may include the outcome of the bet and the betting statistics for the sporting event.

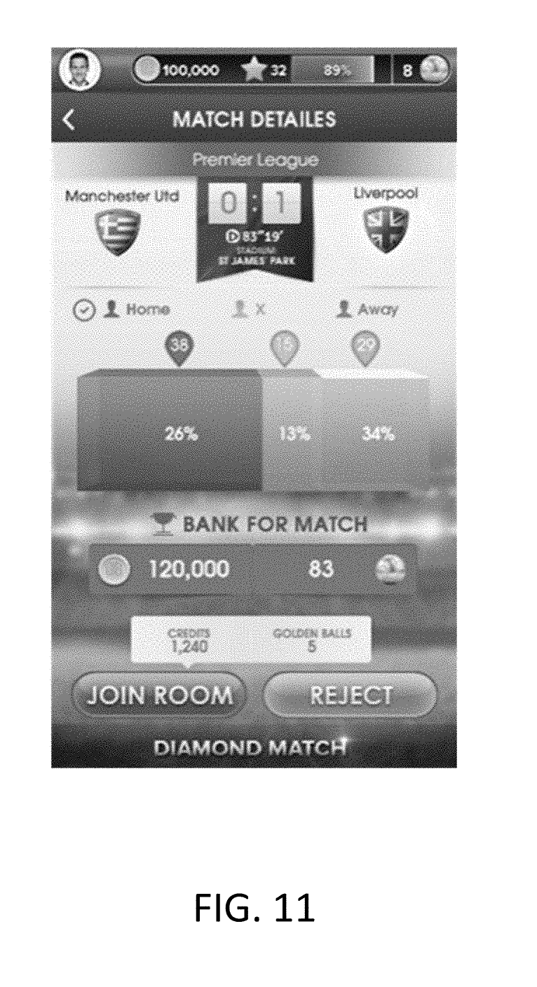

Referring to FIG. 11, an illustrative embodiment of a screen of the computing device 104 is shown for starting another match. The notification of starting another match may be included at the bottom of the screen of computing device 104. This notification may be shown on any of the screens as described above.

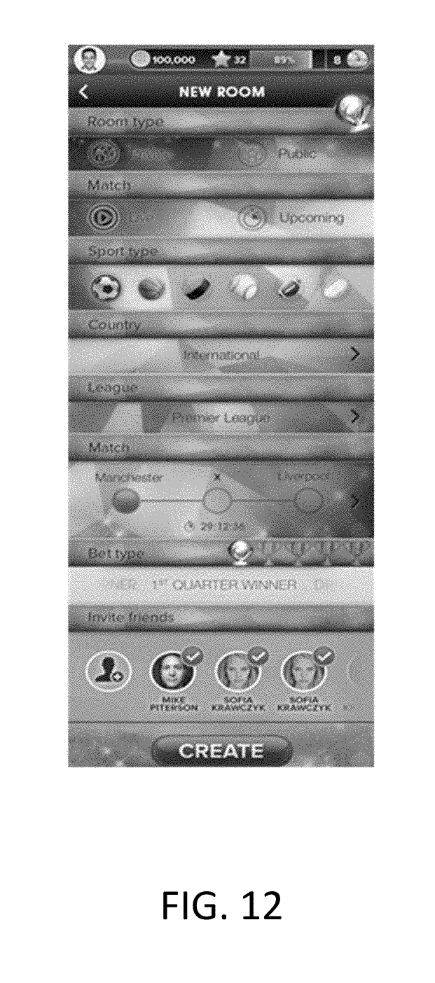

Referring to FIG. 12, an illustrative embodiment of a screen of the computing device 104 is shown for the starting of a new room. The settings may be selected for a room type, match type, sport type, country, league, and/or bet type. The screen may also include an invitation to friends of the user.

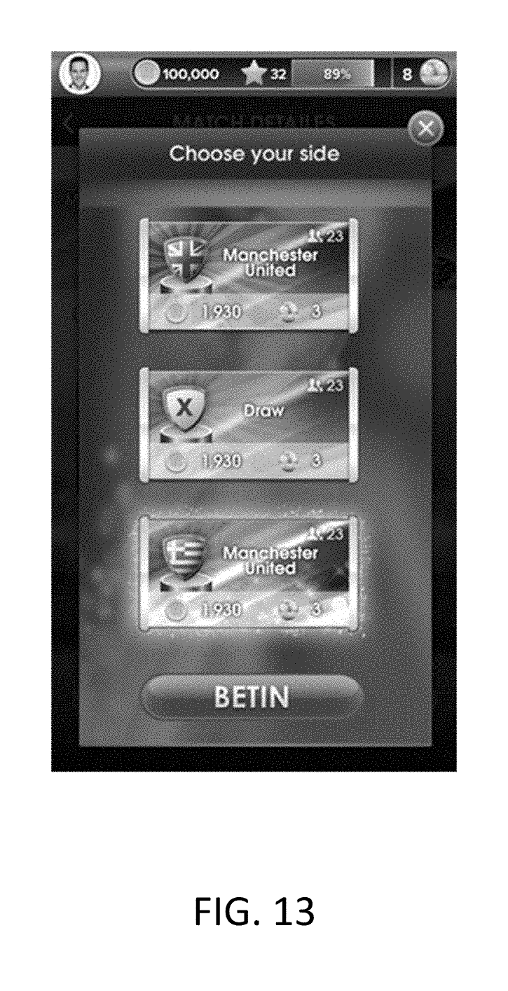

Referring to FIG. 13, an illustrative embodiment of a screen of the computing device 104 is shown for the selection of an outcome for a match. The various teams may be selected and a draw may be selected.

In one illustrative embodiment of the system 100, statistics of the players of the sports betting game may be displayed. The players may be displayed by level, country, and activity. The cases and leads may also be displayed. The primary server 102 may collect statistics on the players of the sports betting game. The primary server 102 may include a display to show the statistics or the primary server 102 may send the data to a computing device 104 to display the statistics.

In one illustrative embodiment of the system 100, a screen of the computing device 104 for a player profile within the sports betting game may be adjusted by the user of the computing device 104. The player profile may include contact information such as full name, email, business phone, mobile phone, and address. The player profile may include personal notes, recent cases, recent leads, billing, and game information. The player profile may also include bets made by the player.

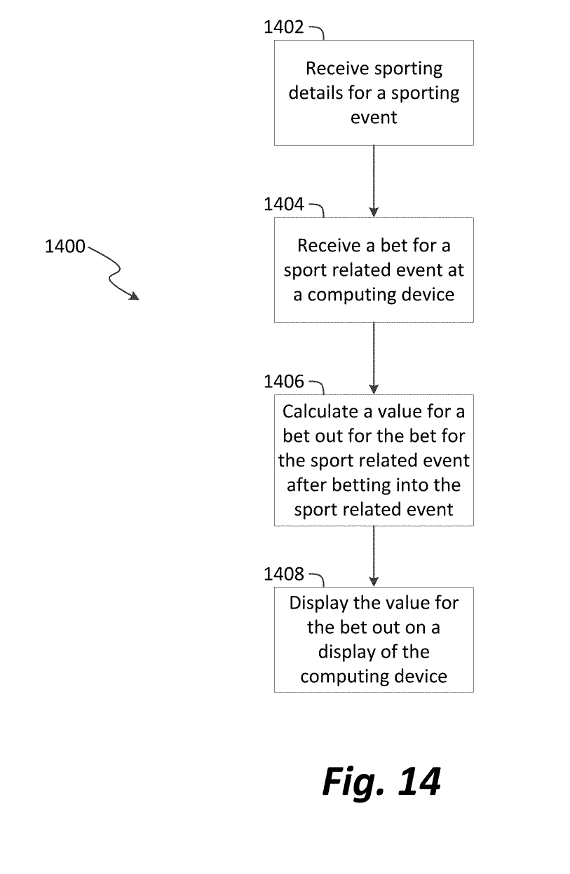

Referring to FIG. 14, in use, the system 100 may execute a method 1400 for simulating betting in real time on sporting events. It should be appreciated that, in some embodiments, the operations of the method 1400 may be performed by any one of the components of the system 100 as shown in FIG. 1. The method begins in block 1402, where the primary server 102 receives sporting details for a sporting event. For example, the primary server may receive the sporting details from the third-party server 106.

In block 1404, the primary server 102 receives a bet for a sport related event at a computing device 104. The computing device 104 may send the bet to the primary server 102 to compile the bets from the computing devices 104.

In block 1406, the primary server 102 calculates a value for a bet out value for the sport related event after betting into the sport related event. The bet out value is calculated based on the odds of the selected team winning as described above. After calculation of the bet out value, the primary server 102 may send the bet out value to the computing device 104.

In block 1408, the computing device 104 may display the value for the bet out value on the display of the computing device 104. The user of the computing device 104 may select whether or not to select the bet out value. If the user selects the bet out value, then the user receives the value for the bet on the sporting event. The user may wait to see if the value of the bet out value changes as the game continues for a better bet out value.

Although certain embodiments have been described and illustrated in exemplary forms with a certain degree of particularity, it is noted that the description and illustrations have been made by way of example only. Numerous changes in the details of construction, combination, and arrangement of parts and operations may be made. Accordingly, such changes are intended to be included within the scope of the disclosure, the protected scope of which is defined by the claims.

1. A system for simulating betting in real time on sporting events, the system comprising:
a server configured to receive sporting event details and communicate with at least one of a plurality of computing devices;
wherein the at least one of the plurality of computing devices includes a user interface to input a bet on a sporting event,
wherein the server is to receive the bets on the sporting event from the at least one of the plurality of computing devices and calculate a bet out value based on betting data received from the at least one of the plurality of computing devices and send the bet out value to the at least one of the plurality of computing devices, and
wherein the at least one of the plurality of computing devices includes a display to show the bet out value in response to reception of the bet out value from the server.

2. The system of claim 1, wherein to receive sporting event details comprises to receive sporting event details from a third-party server.

3. The system of claim 1, wherein the sporting event comprises at least one of a live sporting event, a virtual sporting event, or a retro sporting event.

4. The system of claim 3, wherein to receive sporting event details comprises to receive sporting event details of the live sporting event from a third-party server.

5. The system of claim 4, wherein the server is further to store the sporting event details to be used as a retro sporting event into a database on the server.

6. The system of claim 5, wherein the server is further to retrieve sporting event details stored in the database to simulate the retro sporting event.

7. The system of claim 3, wherein the server is further to generate the virtual sporting event to be betted on based on a collection of sporting event details on a plurality of past sporting events and statistics of teams in the past sporting events.

8. The system of claim 1, wherein the server is further to receive bets on another sporting event from the at least one of the plurality of computing devices.

9. The system of claim 8, wherein the server is further to calculate a relationship between the received bets from the at least one of the plurality of computing devices to determine a payout from the received bets.

10. The system of claim 9, wherein the at least one of the plurality of computing devise is further to display the combination of received bets in a slot-machine style format.

11. A method for simulating betting in real time on sporting events, the method comprising:
receiving, by a first computing device, sporting event details for a sporting event;
receiving, by the first computing device, a bet for the sporting event from a second computing device;
calculating, by the first computing device, a bet out value for the bet for the sporting event after betting into the sporting event;
sending, by the first computing device, the bet out value for the sporting event to the second computing device; and
displaying, by the second computing device, the value for the bet out value on a display of the second computing device in response to the second computing device receiving the bet out value from the first computing device.

12. The method of claim 11, wherein receiving sporting event details comprises receiving sporting event details from a third-party server.

13. The method of claim 11, wherein the sporting event comprises at least one of a live sporting event, a virtual sporting event, or a retro sporting event.

14. The method of claim 13, wherein receiving sporting event details comprises receiving sporting event details of the live sporting event from a third-party server.

15. The method of claim 14, further comprising storing, by the first computing device, the sporting event details to be used as a retro sporting event into a database on the first computing device.

16. The method of claim 15, further comprising retrieving, by the first computing device, sporting event details stored in the database of the first computing device to simulate the retro sporting event.

17. The method of claim 13, further comprising generating, by the first computing device, the virtual sporting event to be betted on based on a collection of sporting event details on a plurality of past sporting events and statistics of teams in the past sporting events.

18. The method of claim 11, further comprising receiving, by the first computing device, bets on another sporting event from the second computing device.

19. The method of claim 18, further comprising calculating, by the first computing device, a relationship between the received bets from the second computing devices to determine a payout from the received bets.

20. The method of claim 9, further comprising displaying, by the second computing device, the combination of received bets in a slot-machine style format.
